(19) United States
(12) Patent Application Publication
(10) Pub. No.: US 2011/0281008 A1
(43) Pub. Date: Nov. 17, 2011

(54) EFFERVESCENT TABLET WITH IMPROVED DISSOLUTION TIME AND METHOD OF USING THE SAME

(75) Inventors: Laknath Anslem Gootenilleke, Plymouth, MN (US); David J. Michael, Minneapolis, MN (US); Kyle M. Johnson, Plymouth, MN (US)

(73) Assignee: AMERILAB TECHNOLOGIES, INC., Plymouth, MN (US)

(21) Appl. No.: 13/086,298

(22) Filed: Apr. 13, 2011

Related U.S. Application Data
(60) Provisional application No. 61/323,603, filed on Apr. 13, 2010.

(51) Int. Cl. A23L 2/40; A23L 2/60

(52) U.S. Cl. 426/548; 426/591

(57) ABSTRACT

An effervescent tablet that includes from about 20% by weight to about 80% by weight effervescent agent that includes an acid and a base, from about 5% by weight to about 25% by weight a first binder, and at least 0.1% by weight oil component that includes at least one of a fatty acid comprising an alkyl chain having at least 10 carbon atoms, safflower oil, canola oil, sunflower oil, flax seed oil, and wheat germ oil, the tablet having a hardness of at least 2 kiloponds. The tablet optionally includes from about 2% by weight to about 20% by weight of a component (e.g. Aspartame) that is insoluble in water, slightly soluble in water, or sparingly soluble in water or exhibits delayed solubility in water.

### CROSS-REFERENCE TO RELATED APPLICATIONS

This application claims priority to U.S. Patent Application Ser. No. 61/323,603 filed Apr. 13, 2010, which is incorporated herein.

### BACKGROUND

The invention is directed to dissolving an effervescent tablet rapidly in water.

Formulating a commercially viable effervescent tablet is more art than science. Whether components can be formulated into an effervescent tablet that maintains its integrity during shipping and dissolves rapidly in water is often unpredictable. It is particularly difficult to formulate an effervescent composition that will form an effervescent tablet that dissolves in cold water in a very short period of time, and that exhibits sufficient integrity as a tablet that it can be manufactured, packaged and shipped without falling apart or exhibiting die wall etching, capping, lamination or picking.

It is often desirable to include sweeteners that have fewer calories than sucrose, or a higher sweetness index than sucrose, which decreases the amount of sweetener required to have the same effect as sucrose. Aspartame is an artificial sweetener used as a sugar substitute in many foods and beverages. Aspartame is only sparingly soluble in room temperature water and even less soluble in cold water. When aspartame is included in an effervescent formulation, which is then formed into an effervescent tablet, the dissolution time of the tablet increases significantly relative to a tablet that includes a sweetener such as sucralose. The increase in dissolution time is also seen when other components that are insoluble to sparingly soluble in water are included in an effervescent tablet.

### SUMMARY

In one aspect, the invention features an effervescent tablet that includes from about 20% by weight to about 80% by weight effervescent agent comprising an acid and a base, from about 5% by weight to about 21% by weight of a first binder, and at least 0.1% by weight of an oil comprising at least one of safflower oil, sesame oil, sunflower oil, flax seed oil, and wheat germ oil, the tablet having a hardness of at least 2 kiloponds. In one embodiment, the tablet further includes from about 2% by weight to about 20% by weight of a first component that is insoluble in water, slightly soluble in water, or sparingly soluble in water, or exhibits delayed solubility in water. In another embodiment, the first component that is insoluble in water, slightly soluble in water, or sparingly soluble in water, or exhibits delayed solubility in water includes a sweetening agent and the effervescent tablet comprises from about 2% by weight to about 20% by weight of the sweetening agent. In other embodiments, the tablet further includes from about 2% by weight to about 20% by weight of an agent selected from the group consisting of a flavor agent and a color agent, the agent being insoluble in water, slightly soluble in water, sparingly soluble in water, or exhibiting delayed solubility in water.

In some embodiments, the first component that is insoluble in water, slightly soluble in water, or sparingly soluble in water, or exhibits delayed solubility in water includes an agent selected from the group consisting of a flavor agent and a color agent, the agent being present in the tablet in an amount of from about 4% by weight to about 20% by weight.

In other embodiments, a tablet disclosed herein includes at least 0.5% by weight oil.

In some embodiments, a tablet disclosed herein includes at least 4% by weight of the component that is insoluble in water, slightly soluble in water, or sparingly soluble in water, or exhibits delayed solubility in water.

In other embodiments, the tablet includes a flavor agent that includes at least one of maltodextrin, dextrin, starch, modified starch, corn syrup solids, acacia gum, and agar agar. In another embodiment, the tablet includes a flavor agent that includes a carbohydrate selected from the group consisting of sucrose, glucose, lactose, fructose, maltose, ribose, isomalt, mannitol, xylitol, lactitol, maltitol, pentatol, arabinose, pentose, xylose, galactose, hydrogenated starch hydrolysate and combinations thereof.

In some embodiments, the tablet further includes at least one of starch, modified starch, calcium phosphate, calcium phosphate dibasic, calcium phosphate tribasic, and lecithin.

In some embodiments, the tablet further includes from about 2% by weight to about 20% by weight of a first component selected from the group consisting of aspartame, stevia, cellulose, ethyl cellulose, maltodextrin, dextrin, starch, silicon dioxide, modified starch, alginate, butylated hydroxyanisole, butylated hydroxytoluene, calcium phosphate, hydroxypropyl cellulose, methyl cellulose, and combinations thereof. In one embodiment, the tablet includes from about 4% by weight to about 20% by weight of the first component.

In another embodiment, the component that is insoluble in water, slightly soluble in water, or sparingly soluble in water, or exhibits delayed solubility in water includes at least one of aspartame and stevia.

In some embodiments, the tablet dissolves in 40° F. water in less than 150 seconds.

In other embodiments, the tablet has a hardness of at least 4 kiloponds and dissolves in 75° F. water in less than 225 seconds.

In another embodiment, the oil component has a hydrophilic lypophilic balance value of no greater than 10.

In some embodiments, the tablet includes at least 0.5% by weight of the oil component.

In one embodiment, the effervescent tablet includes from about 5% by weight to about 25% by weight binder, from about 20% by weight to about 80% by weight effervescent agent comprising an acid and a base, from about 2% by weight to about 20% by weight of a first component that is insoluble in water, slightly soluble in water, or sparingly soluble in water, or exhibits delayed solubility in water, and at least 0.5% by weight of an oil component that includes at least one of a fatty acid having an alkyl chain of at least 10 carbon atoms, safflower oil, sesame oil, sunflower oil, flax seed oil, canola oil, and wheat germ oil, the tablet having a hardness of at least 2 kiloponds.

In other embodiments, the effervescent tablet includes from about 5% by weight to about 25% by weight binder, from about 20% by weight to about 80% by weight of an effervescent agent comprising an acid and a base, from about 2% by weight to about 20% by weight of a sweetening agent selected from the group consisting of aspartame and stevia, and at least 0.1% by weight oil having a density greater than 0.900 grams per cubic centimeter, the tablet having a hardness of at least 2 kiloponds and dissolving in water having a temperature of 40° F. in less than 200 seconds. In some embodiments, the oil is wheat germ oil and the tablet includes at least 0.5% by weight of the wheat germ oil.

In another aspect, the invention features an effervescent tablet that includes: from about 20% by weight to about 80% by weight effervescent agent that includes an acid and a base, from about 4% by weight to about 20% by weight of a component that is insoluble in water, slightly soluble in water, or sparingly soluble in water, from about 5% by weight to about 25% by weight a first binder; and at least 0.1% by weight oil component that includes at least one of 1) a fatty acid that includes an alkyl chain having at least 10 carbon atoms, and 2) an oil that includes at least one of safflower oil, canola oil, sunflower oil, flax seed oil, and wheat germ oil, the tablet having a hardness of at least 2 kiloponds. In some embodiments the tablet dissolves in 40° F. water in less than 250 seconds. In other embodiments the tablet dissolves in 40° F. water in less than 200 seconds. In other embodiments the tablet dissolves in 40° F. water in less than 150 seconds. In another embodiment the tablet dissolves in 40° F. water in less than 120 seconds.

In one embodiment the component that is insoluble in water, slightly soluble in water, or sparingly soluble in water is a sweetener and is present in an amount of from about 2% by weight to about 20% by weight.

In other embodiments, the tablet further includes an agent selected from the group consisting of a flavor agent and a color agent, and the agent includes a carrier, the carrier being at least one of insoluble in water, slightly soluble in water, and a second binder. In another embodiment the carrier is a second binder. In other embodiments the carrier is a carbohydrate. In some embodiments the carrier is selected from the group consisting of maltodextrin, dextrin, starch, modified starch, corn syrup solids, acacia gum, agar, and combinations thereof. In other embodiments the carrier includes a carbohydrate selected from the group consisting of sucrose, glucose, lactose, levulose, fructose, maltose, ribose, dextrose, isomalt, sorbitol, mannitol, xylitol, lactitol, malitol, pentatol, arabinose, pentose, xylose, galactose, hydrogenated starch hydrolysate, and combinations thereof. In some embodiments, the carrier is insoluble in water. In other embodiments the carrier is sparingly soluble in water. In other embodiments the carrier includes at least one of starch and modified starch. In some embodiments the carrier is calcium phosphate. In other embodiments is at least one of calcium phosphate dibasic and calcium phosphate tribasic. In some embodiments the tablet dissolves in 40° F. water faster than an identically formulated and tabletted tablet that does not include the agent. In some embodiments, the color agent includes at least one of FD&C Red No. 40 and FD&C Blue No. 1. In other embodiments, the color agent includes at least one of FD&C Red No. 40, FD&C Yellow No. 5, and FD&C Yellow No. 6.

In some embodiments, the oil component includes a saturated fatty acid. In other embodiments, the oil component includes saturated fatty acid, monounsaturated fatty acid and polyunsaturated acid. In one embodiment, the oil component includes at least one of linoleic acid and palmitic acid. In another embodiment, the oil component includes linoleic acid and oleic acid. In another embodiment, the tablet further includes tocopherol.

In one embodiment, the oil component has a hydrophilic lypophilic balance value of no greater than 10. In other embodiments, the oil component has a hydrophilic lypophilic balance value of no greater than 9.

In another embodiment the tablet further includes lecithin.

In one embodiment, the sweetener includes aspartame. In other embodiments the tablet dissolves in 40° F. water in less than 150 seconds. In another embodiment the tablet dissolves in 40° F. water in less than 120 seconds.

In another embodiment, the effervescent tablet includes from about 5% by weight to about 25% by weight binder, from about 20% by weight to about 80% by weight of an effervescent agent that includes an acid and a base, from about 2% by weight to about 20% by weight aspartame, and at least 0.1% by weight oil having a density greater than 0.900 grams per cubic centimeter, the tablet having a hardness of at least 2 kiloponds and dissolving in water having a temperature of 40° F. in less than 200 seconds. In one embodiment, the oil component has a hydrophilic lypophilic balance value of no greater than 10. In another embodiment, the oil component has a hydrophilic lypophilic balance value of no greater than 9. In some embodiments, the oil component includes a fatty acid.

In other embodiments, the effervescent tablet includes from about 5% by weight to about 25% by weight binder, from about 20% by weight to less than 80% by weight effervescent agent that includes an acid and a base, from about 2% by weight to about 20% by weight aspartame, and at least 0.1% by weight oil consisting of safflower oil, canola oil, sunflower oil, flax seed oil, wheat germ oil, or a combination thereof, the tablet having a hardness of at least 2 kiloponds and dissolving in water having a temperature of 40° F. in less than 200 seconds. In one embodiment, the oil component has a hydrophilic lypophilic balance value of no greater than 10. In other embodiments, the oil component has a hydrophilic lypophilic balance value of no greater than 9. In some embodiments, the oil component includes a fatty acid.

The invention features an ability to increase the disintegration rate (i.e., decrease the disintegration time) of an effervescent tablet.

The invention also features effervescent tablets that are formulated with compounds that are insoluble to sparingly soluble in water and an oil component and that exhibit good dissolution times in water. Some formulations of the effervescent tablet also exhibit good dissolution times in cold water.

The invention also features effervescent tablets that are formulated with aspartame and that disintegrate rapidly in cold water.

Other features and advantages will be apparent from the following description of the preferred embodiments and from the claims.

### GLOSSARY

In reference to the invention, these terms have the meanings set forth below:

The phrase “insoluble in water” means more than 10,000 parts of water having a temperature of 72° F. (22.2° C.) at atmospheric pressure are needed to dissolve one part solute.

The phrase “slightly soluble in water” means from 100 parts to 1000 parts water having a temperature of 72° F. at atmospheric pressure are needed to dissolve one part of solute.

The phrase “sparingly soluble in water” means from 30 parts to 100 parts water having a temperature of 72° F. at atmospheric pressure are needed to dissolve one part of solute.

The phrase “soluble in water” means less than 30 parts water having a temperature of 72° F. at atmospheric pressure are needed to dissolve one part of solute.

The phrase “delayed solubility” means not dissolving immediately when placed in water having a temperature of 72° F. but dissolving within five minutes after being placed in the water.

### DETAILED DESCRIPTION

The effervescent tablet includes an oil component, an effervescent agent that includes an acid and a base, a binder and optionally a component that is insoluble, slightly soluble or sparingly soluble in water or exhibits delayed solubility in water (e.g., a sweetener such as aspartame or stevia). The oil component preferably speeds the rate of disintegration of the effervescent tablet in water relative to the same tablet formulated with mineral oil instead of the oil component. In other words, the effervescent tablet can be formulated such that it dissolves faster than an effervescent tablet formulated and tableted in an identical manner with the exception that the oil component is replaced with mineral oil.

The tablet can be formulated so that the rate of disintegration is increased (i.e., total disintegration time is decreased) when the tablet is placed in cold water, room temperature water, hot water, or a combination thereof.

The tablet preferably dissolves to a clear solution in water such that there are no visible particulates floating in the resulting composition after the tablet has dissolved in the water. A clear solution can exhibit a color.

The effervescent tablet has a hardness of at least 2 kiloponds (Kp), at least 3 Kp, at least 4 Kp, or even at least 5 Kp, and can dissolve in water having a temperature of 40° F. (degrees Fahrenheit) (about 4.4° C. (degrees Celsius)) in less than 250 seconds, less than 220 seconds, less than 190 seconds, less than 150 seconds, no greater than 120 seconds, or even no greater than 100 seconds, or a combination thereof. Alternatively or in addition, the effervescent tablet has a hardness of at least 2 kiloponds, at least 3 Kp, at least 4 Kp, or even at least 5 Kp, and can dissolve in water having a temperature of 75° F. (about 24° C.) in less than 300 seconds, less than 250 seconds, less than 225 seconds, less than 190 seconds, no greater than 120 seconds, or even no greater than 100 seconds.

Useful oil components include, e.g., oils, fatty acids, tocopherols, tocotrienols, triglycerides, and combinations thereof. The oil component preferably includes an alkyl chain that includes a polar end group, e.g., a carboxylic acid group, a hydroxyl group, and combinations thereof. The alkyl chain includes at least 10 carbon atoms, at least 12 carbon atoms, or even at least 14 carbon atoms.

Useful fatty acids include, e.g., saturated fatty acids, monounsaturated fatty acids, polyunsaturated fatty acids, and combinations thereof. Suitable saturated fatty acids include, e.g., lauric, palmitic acid and stearic acid. One example of a suitable monounsaturated fatty acid is oleic acid. Examples of suitable polyunsaturated fatty acids include linoleic acid and linolenic acid.

Suitable tocopherols include, e.g., alpha, beta, gamma and delta tocopherols, and combinations thereof.

Useful oils include, e.g., wheat germ oil, canola oil, safflower oil, sunflower seed oil, sesame oil, cotton seed oil, corn oil, palm oil, coconut oil, flax seed oil, olive oil, and combinations thereof). One useful class of oils includes oils having a density of at least 0.900 g/cm³, from about 0.906 g/cm³ to about 0.960 g/cm³, from about 0.906 g/cm³ to about 0.940 g/cm³, or even from about 0.910 g/cm³ to 0.930 g/cm³, and mixtures thereof. Useful commercially available oils include, e.g., wheat germ oils identified as 9-11 from Vitamin, Inc. (Chicago, Ill.), and high oleic safflower oil from Columbus Food Company (Des Plaines, Ill.) and from Mays Chemical Company (Chicago, Ill.).

Some useful oil components have a hydrophilic lypophilic balance (HLB) value of no greater than 10, no greater than about 9, or even no greater than about 8.

The effervescent tablet preferably includes less than 2% by weight, less than 1% by weight, less than 0.8% by weight, at least 0.1% by weight, at least 0.2% by weight, at least 0.3% by weight, at least 0.4% by weight, at least about 0.5% by weight, at least 0.6% by weight, from about 0.3% by weight to about 1% by weight, from about 0.3% by weight to about 0.8% by weight, or even from about 0.5% by weight to about 0.8% by weight of the oil component.

The effervescent tablet preferably includes at least 0.8% by weight, at least 1% by weight, at least 2% by weight, at least 4% by weight, less than 20% by weight, less than 10% by weight, less than 8% by weight, less than 5% by weight, from about 1% by weight to about 20% by weight, from about 2% by weight to about 20% by weight, from about 4% by weight to about 20% by weight, from about 2% by weight to about 10% by weight, from about 2% by weight to about 8% by weight, from about 3% by weight to about 5% by weight, or even from about 4% by weight to about 5% by weight of a component that is insoluble, slightly soluble, or sparingly soluble in water, or exhibits delayed solubility in water. One example of a component that is insoluble, slightly soluble, or sparingly soluble in water or exhibits delayed solubility in water is certain sweeteners. Aspartame and stevia are examples of sweeteners that are insoluble, slightly soluble, or sparingly soluble in water, or exhibit delayed solubility in water. Various stevia products are commercially available including, e.g., Steviol glycosides (e.g., Rebaudioside A).

The effervescent tablet can optionally include water soluble sweeteners including, e.g., sugars such as sucrose, glucose, invert sugar, fructose, ribose, lactose, maltose, isomalt, tagatose, sucralose, and mixtures thereof, saccharin and its various salts (e.g., sodium and calcium salt of saccharin), cyclamic acid and its various salts, acesulfame potassium, dihydrochalcone, glycyrrhizin, and sugar alcohols including, e.g., erythritol, xylitol, sorbitol, sorbitol syrup, lactitol, maltitol, and mannitol, and combinations thereof. When present, the effervescent tablet preferably includes at least 0.8% by weight, at least 1% by weight, at least 2% by weight, at least 4% by weight, less than 10% by weight, less than 8% by weight, less than 5% by weight, from about 1% by weight to about 10% by weight, from about 2% by weight to about 8% by weight, or even from about 3% by weight to about 5% by weight of a sweetener that is insoluble, slightly soluble, or sparingly soluble in water, or exhibits delayed solubility in water.

The component that is insoluble, slightly soluble or sparingly soluble in water, or exhibits delayed solubility in water can also be present as a carrier for other components such as flavor agents and color agents. Examples of other components that are insoluble, slightly soluble or sparingly soluble in water or exhibit delayed solubility in water include some forms of starch, modified starch, maltodextrin, dextrin, butylated hydroxyanisole, butylated hydroxytoluene, calcium phosphate, hydroxypropyl cellulose, methyl cellulose, ethyl cellulose, carboxymethyl cellulose (e.g., sodium carboxymethyl cellulose), hydroxyethyl cellulose, alginate, and combinations thereof.

The effervescent agent is activated when contacted with an aqueous liquid, e.g., when the effervescent agent is placed in a glass of water. The water liberates the acid and base and enables the acid and base to react each other to produce a gas (e.g., carbon dioxide). The effervescent tablet preferably includes at least about 50% by weight, at least about 60% by weight, at least about 70% by weight, from about 65% by weight to about 85% by weight, or even from about 70% by weight to about 80% by weight effervescent agent.

Useful acids include, e.g., citric acid, aspartic acid, malic acid, adipic acid, tartaric acid, fumaric acid, succinic acid, sodium acid pyrophosphate, lactic acid, hexamic acid, amino acid hydrochlorides, and acid salts and acid anhydrides thereof, and mixtures thereof. Preferably the effervescent tablet includes from 20% by weight to about 80% by weight, from about 35% by weight to about 70% by weight, or even from about 45% by weight to about 60% by weight acid.

The base of the effervescent agent preferably is capable of generating a gas such as carbon dioxide in the presence of an acid source and water. Examples of suitable bases include potassium bicarbonate, sodium bicarbonate, sodium carbonate, sodium sesquicarbonate, potassium carbonate, calcium carbonate, magnesium carbonate, zinc carbonate, and mixtures thereof. The effervescent tablet can include from 5% by weight to about 40% by weight, from about 10% by weight to about 35% by weight, from about 10% by weight to about 30% by weight, or even from about 15% by weight to about 25% by weight base.

The effervescent tablet also includes binder. Certain solid substrates present in some flavor agents and some color agents may exhibit binding properties (i.e., function as a binder) in an effervescent tablet. The effervescent tablet preferably includes a binder in addition to any binder that is associated with the flavor agent or the color agent (i.e., a binder that is not the solid substrate component of a flavor agent or a color agent), hereinafter referred to as a “neat binder.” Examples of suitable neat binders include, e.g., starches, natural gums, cellulose gums, microcrystalline cellulose, methylcellulose, cellulose ethers, sodium carboxymethylcellulose, ethyl cellulose, gelatin, dextrose, lactose, sucrose, sorbitol, mannitol, polyethylene glycol, polyvinylpyrrolidone, pectins, alginates, polyacrylamides, polyvinyloxoazolidone, polyvinylalcohols and mixtures thereof. Preferably the binder is water soluble. When a neat binder is present in the effervescent tablet, the tablet preferably includes no greater than 30% by weight, no greater than 25% by weight, no greater than about 20% by weight, from about 5% by weight to about 25% by weight, or even from about 10% by weight to about 20% by weight neat binder.

The effervescent tablet can optionally include additional ingredients, including, e.g., lubricants, color agents, nutritional ingredients (e.g., nutritional supplements), surfactant, and combinations thereof.

The oil component can provide the lubricant function by enabling the effervescent formulation to be tableted without sticking to the tablet press or creating other tableting problems. The composition optionally includes additional lubricants including, e.g., water insoluble, water dispersible, and water soluble lubricants, and combinations thereof. Examples of useful water soluble lubricants include sodium benzoate, polyethylene glycol, L-leucine, adipic acid, and combinations thereof. An example of a useful class of water insoluble lubricants includes oils (e.g., mineral oil). Other water insoluble lubricants include, e.g., animal fats, polyoxyethylene monostearate, talc, and combinations thereof. When additional lubricant is present in the effervescent tablet, the tablet preferably includes less than 2% by weight, less than 1% by weight, less than 0.8% by weight, from about 0.05% by weight to about 1% by weight, or even from about 0.05% by weight to about 0.8% by weight of the additional lubricant.

The effervescent tablet preferably includes a flavor agent, which can be any suitable flavor agent. The flavor agent imparts any suitable flavor to the composition, including, e.g., lemon (e.g., lemonade), orange, grape, tropical punch, lime, grapefruit, apple, pear, peach, strawberry, raspberry, cherry, plum, pineapple, apricot, guava, mango, papaya, tea, mint, cocoa, vanilla, almond, coffee, and combinations thereof. Useful flavor agents include natural and artificial flavor agents including, e.g., volatile oils, synthetic flavor oils, flavoring aromatics, oils, liquids, oleoresins and extracts derived from plants, leaves, flowers, fruits, stems and combinations thereof. Useful flavor agents include, e.g., citric oils, e.g., lemon, orange, grape, lime and grapefruit oils, fruit essences including, e.g., lemon, apple, pear, peach, grape, strawberry, raspberry, cherry, plum, pineapple, apricot, guava, mango, papaya, and other fruit flavors, ice tea flavoring, and combinations thereof. Other useful flavor agents include, e.g., aldehydes and esters (e.g., benzaldehyde (cherry, almond)), citral, i.e., alpha-citral (lemon, lime), neral, i.e., beta-citral (lemon, lime), decanal (orange, lemon), aldehyde C-8 (citrus fruits), aldehyde C-9 (citrus fruits), aldehyde C-12 (citrus fruits), tolyl aldehyde (cherry, almond), 2,6-dimethyloctanal (green fruit), 2-dodedenal (citrus, mandarin), and mixtures thereof. The flavor agents can be in a variety of forms including, e.g., solids (e.g., powders, granulations, spherical and non-spherical particles, and combinations thereof), liquids (e.g., oils), pastes, and combinations thereof. A variety of techniques are available for forming flavor agents, including, e.g., spray drying, granulating, encapsulation, and combinations thereof.

Some useful flavor agents include a solid substrate component (i.e., a carrier) in addition to a flavor component. Some carriers are soluble in water, insoluble in water, slightly soluble in water, or sparingly soluble in water or exhibit delayed solubility in water. Useful carriers include, e.g., sucrose, glucose, lactose, levulose, fructose, maltose, ribose, arabinose, pentose, xylose, galactose, and isomalt (e.g., a mixture of glucopyranosylmannitol dihydrate and glucopyranosylsorbitol), and combinations thereof, and sugar alcohols including, e.g., sorbitol, mannitol, xylitol, lactitol, maltitol, and pentatol, and combinations thereof. Other carriers include, e.g., starches, hydrolyzed starches (e.g., maltodextrin), dextrin (e.g., water soluble and partially water soluble dextrins), cyclodextrin, and emulsifying polymers (e.g., gum arabic), pectins, xanthans, alginates, cellulose (e.g., carboxymethyl cellulose, methyl cellulose, ethyl cellulose, hydroxyethylcellulose, and hydroxypropyl cellulose), corn syrup (e.g., corn syrup solids), silicon dioxide, soy lecithin, gum arabic, modified starch (e.g., sodium starch octenyl succinates), whey protein, gelatin, butylated hydroxyanisole, butylated hydroxytoluene, and combinations thereof.

Some flavor agents are encapsulated. Encapsulated flavors can be soluble in water, insoluble in water, slightly soluble in water, sparingly soluble in water, or exhibit delayed solubility in water. Encapsulated flavors often do not dissolve immediately when placed in water, but dissolve over time. Encapsulating agents for encapsulating flavors include the above-described carriers.

The flavor agent is preferably present in the effervescent tablet in an amount of less than 5% by weight, less than 4% by weight flavor agent, at least about 0.1% by weight, from about 0.1% by weight to about 3% by weight, or even from about 0.5% by weight to about 3% by weight.

Useful color agents include, e.g., food, drug and cosmetic (FD&C) colors including, e.g., dyes, pigments, lakes, natural colorants, and derived colorants. Useful lakes include dyes absorbed on aluminum hydroxide and other suitable carriers. Examples of suitable colors include FD&C Red No. 3, FD&C Red No. 40, FD&C Blue No. 1, FD&C Blue No. 2, FD&C Yellow No. 5, FD&C Yellow No. 6, FD&C Green No. 3, and combinations thereof.

The color agent optionally includes a carrier in addition to the coloring component. Useful carriers can be soluble in water, insoluble in water, slightly soluble in water, sparingly soluble in water, or exhibit delayed solubility in water. Useful carriers include, e.g., sucrose, glucose, lactose, levulose, fructose, maltose, ribose, arabinose, pentose, xylose, galactose, and isomalt (e.g., a mixture of glucopyranosylmannitol dihydrate and glucopyranosylsorbitol), and combinations thereof, and sugar alcohols including, e.g., sorbitol, mannitol, xylitol, lactitol, maltitol, and pentatol, and combinations thereof. Other carriers include, e.g., starch, modified starch, hydrolyzed starches (e.g., maltodextrin), dextrin (e.g., water soluble and partially water soluble dextrins), and emulsifying polymers (e.g., gum arabic), pectins, xanthans, alginates, cellulose (e.g., carboxymethyl cellulose, methyl cellulose, ethyl cellulose, hydroxyethylcellulose, and hydroxypropyl cellulose), corn syrup (e.g., corn syrup solids), silicon dioxide, soy lecithin, butylated hydroxyanisole, butylated hydroxytoluene, and combinations thereof. Starch is an example of a water insoluble carrier.

The effervescent tablet includes any suitable amount of color agent including, e.g., less than 3% by weight, less than 2% by weight, less than 1% by weight, less than 0.5% by weight, at least about 0.05% by weight, or even from about 0.1% by weight to about 0.5% by weight color agent.

The effervescent tablet optionally includes a desiccant. A variety of desiccants can be used in the effervescent tablet including, e.g., potassium carbonate, sodium carbonate, calcium carbonate, magnesium oxide, and combinations thereof. Desiccant can be present in the composition in an amount of less than 5% by weight, less than 3% by weight, or even less than 0.5% by weight.

The ingredients of the effervescent composition can be sieved as necessary prior to combining with mixing.

The effervescent tablet can be of a variety of sizes. A useful effervescent tablet has a diameter of at least about 10 mm, at least about 15 mm, from about 16 mm to about 30 mm, from about 16 mm to about 25 mm, about 19 mm, or even about 21 mm, a weight of from about 1 g to about 6 g, from about 1.5 g to about 5 g, from about 2.0 g to about 4 g, from about 2.1 to about 3.0 g, or even from about 2.1 g to about 2.4 g, and a hardness of at least 2 kp, at least 3 kp, no greater than about 10 kp, from about 3 kp to about 10 kp, or even from about 3 kp to about 7 kp.

The tablet preferably is essentially free of, or even free of, picking, capping, die wall etching and lamination. A tablet is essentially free of picking, capping, die wall etching and lamination if it is a commercially viable tablet.

The effervescent tablet is preferably stored in a moisture-proof package. Useful moisture proof packages are in a variety of forms, including, e.g., sealed metal foil pouches, blister packs, and desiccant capped tubes. Useful packaging materials further include, e.g., plastic, metal foil, plastic films, and blister packaging.

The effervescent composition is well-suited to the mass production of effervescent tablets that are free from picking, die wall etching, capping and lamination. Any suitable tablet mass production equipment and processes can be used. Examples of useful tableting processes for effervescent compositions are described in Pharmaceutical Dosage Forms, Vol. 1, (Herbert A. Lieberman et al. eds, 2^{nd} ed. 1989) and incorporated herein. The tablets can then be manufactured in an automated process in which multiple dies of a tablet press are filled sequentially or simultaneously with the effervescent composition, two punches compress the effervescent composition to form the tablet(s), and then the tablet(s) is ejected from the die. The tablet is then placed in packaging material, which is then sealed to form an air tight sealed package. The packaged tablet can be further processed by conveying it to other processing stations including, e.g., additional packaging stations for further packaging, e.g., boxing and bagging.

The tablet manufacturing and initial packing operations are preferably performed in a controlled environment in which the temperature and humidity are controlled. Preferably the controlled environment has less than 18 grains, less than 16 grains, or even less than 15 grains of moisture per pound of air at a temperature of 72° F. (22.2° C.).

A useful method of using the effervescent tablets includes dissolving a tablet in excess water, e.g., an eight ounce glass of water or a bottle of refrigerated water, to form an aqueous solution, and then ingesting the resulting composition. After addition of the effervescent composition to an aqueous liquid, the composition optionally can be stirred to facilitate dispersion and/or dissolution in the aqueous liquid.

The invention will now be described by way of the following examples. All parts, ratios, percents and amounts stated in the Examples are by weight unless otherwise specified.

### EXAMPLES

### Test Procedures

Test procedures used in the examples include the following. All ratios and percentages are by weight unless otherwise indicated.

### Cold Water Dissolution Time Test Method

A tablet is placed in a glass vial of 240 ml of water having a temperature of 40° F. A timer is started simultaneously with the placing of the tablet in the water. The effervescence and size of the tablet is observed. When the tablet is essentially gone and all that remains of the tablet is small dispersed particles the timer is stopped. The time reflected on the timer is recorded in units of seconds.

### Room Temperature Water Dissolution Time Test Method

A tablet is placed in a glass vial of 240 ml of water having a temperature of 75° F. A timer is started simultaneously with the placing of the tablet in the water. The effervescence and size of the tablet is observed. When the tablet is essentially gone and all that remains of the tablet is small dispersed particles the timer is stopped. The time reflected on the timer is recorded in units of seconds.

### Dissolution Analysis of Flavor Agents

ULTRASEAL 250 orange flavor in an amount of 250 mg was added to approximately 236 ml of 40° F. water. The orange flavor was observed to immediately cloud the solution and settle to the bottom of the vessel. After five minutes almost no change was observed.

Strawberry flavor (Firmenich Inc., Princeton, N.J.) in an amount of 250 mg was added to approximately 236 ml of 40° F. water. The strawberry flavor initially sat on the surface of the water and then particles quickly began falling into the body of the water where upon they dissolved to form a solution. A majority of the strawberry flavor particles went into solution after three and a half minutes.

### Controls 1-3

A uniform granulation was prepared by combining citric acid fine granular, potassium bicarbonate, sorbitol instant, sodium bicarbonate, aspartame, potassium carbonate, sodium carbonate 100 grade, sucralose micronized powder, mineral oil, magnesium oxide, FD&C Red No. 40 powder, ascorbic acid, acesulfame potassium, and sodium benzoate in the amounts set forth below in Table 1. Controls 1 and 3 additionally included flavor. The ingredients were combined with mixing in a Kitchen Aid mixer. The amount of each ingredient is in units of % by weight of the formulation. When necessary, an ingredient was sieved using a number 12 sieve prior to addition to the mixture.

The compositions were then tableted on a Cadmach rotary compression machine using 19 millimeter high density polyethylene inserted tools. The average mass, thickness, and hardness of six tablets were measured and are reported in Table 1. The tablets were then tested according to the Dissolution Time Test Method and the average tablet dissolution time is reported in Table 1 in units of seconds.

### Examples 1-3

A uniform granulation was prepared by combining citric acid fine granular, potassium bicarbonate, sorbitol instant, sodium bicarbonate, aspartame, flavor, potassium carbonate, sodium carbonate 100 grade, sucralose micronized powder, safflower oil (Example 1) or wheat germ oil (Examples 2 and 3), magnesium oxide, FD&C Red No. 40 powder, ascorbic acid, acesulfame potassium, and sodium benzoate in the amounts set forth below in Table 1. The ingredients were combined with mixing in a Kitchen Aid mixer. The amount of each ingredient is in units of % by weight based on the total weight of the formulation. When necessary, an ingredient was sieved using a number 12 sieve prior to addition to the mixture.

The composition was then tableted on a Cadmach rotary compression machine using 19 millimeter high density polyethylene inserted tools. The average mass, thickness, and hardness of six tablets was measured and is reported in Table 1. The tablets were then tested according to the Dissolution Time Test Method and the average tablet dissolution time is reported in Table 1 in units of seconds.

TABLE 1

| Component | Example 1 | Example 2 | Control 1 | Control 2 | Control 3 | Example 3 |
|---|---|---|---|---|---|---|
| Citric Acid | 51.11 | 51.11 | 51.11 | 52.34 | 51.22 | 51.22 |
| Potassium | 15.04 | 15.04 | 15.04 | 15.41 | 15.07 | 15.07 |
| Bicarbonate | | | | | | |
| Sorbitol | 15.04 | 15.04 | 15.04 | 15.41 | 15.07 | 15.07 |
| Sodium | 6.45 | 6.45 | 6.45 | 6.60 | 6.46 | 6.46 |
| Bicarbonate | | | | | | |
| Aspartame | 4.09 | 4.09 | 4.09 | 4.19 | 4.10 | 4.10 |
| Strawberry | 2.36 | 2.36 | 2.36 | 0.00 | 0.00 | 0.00 |
| Flavor¹ | | | | | | |
| Orange Flavor² | 0.00 | 0.00 | 0.00 | 0.00 | 2.15 | 2.15 |
| Potassium | 1.72 | 1.72 | 1.72 | 1.76 | 1.72 | 1.72 |
| Carbonate | | | | | | |
| Sodium Carbonate | 1.50 | 1.50 | 1.50 | 1.54 | 1.51 | 1.51 |
| Sucralose | 1.04 | 1.04 | 1.04 | 1.07 | 1.04 | 1.04 |
| Safflower oil | 0.69 | 0.00 | 0.00 | 0.00 | 0.00 | 0.00 |
| Wheat Germ Oil | 0.00 | 0.69 | 0.00 | 0.00 | 0.00 | 0.69 |
| Mineral Oil | 0.00 | 0.00 | 0.69 | 0.70 | 0.69 | 0.00 |
| Magnesium Oxide | 0.10 | 0.10 | 0.10 | 0.11 | 0.10 | 0.10 |
| Color Agent | 0.14 | 0.14 | 0.14 | 0.15 | 0.14 | 0.14 |
| Ascorbic Acid | 0.33 | 0.33 | 0.33 | 0.34 | 0.33 | 0.33 |
| Acesulfame | 0.28 | 0.28 | 0.28 | 0.29 | 0.28 | 0.28 |
| Potassium | | | | | | |
| Sodium Benzoate | 0.10 | 0.10 | 0.10 | 0.10 | 0.10 | 0.10 |
| Mass (g) | 2.36 | 2.35 | 2.32 | 2.30 | 2.34 | 2.33 |
| Thickness (in) | 0.240 | 0.240 | 0.243 | 0.240 | 0.247 | 0.240 |
| Hardness (Kp) | 3.0 | 3.5 | 3.1 | 3.6 | 3.2 | 3.2 |
| Dissolution Time | 80 | 85-90 | 95 | 100 | 240-250 | 125-130 |
| (seconds) | | | | | | |

¹Strawberry flavor including from 10%-25% flavor, greater than 50% maltodextrin, and from 1%-10% triacetin (Firmenich Inc., Princeton, New Jersey)
²ULTRASEAL 250 orange flavor from Givaudan Schweiz AG (Dubendorf, Switzerland)

### Control 4 and Examples 4-9

Uniform granulations were prepared by combining citric acid (granular), potassium bicarbonate, sorbitol instant, sodium bicarbonate, sodium carbonate and an oil in a ribbon blender in the amounts (in units of % by weight based on the total weight of the formulation) set forth below in Table 2. When necessary, an ingredient was sieved using a number 12 sieve prior to addition to the mixture. The granulations were mixed for twenty-five minutes.

The oil in each control formulation was as follows: Control 4, mineral oil; Example 4, wheat germ oil, Example 5, safflower oil; Example 6, sesame oil; Example 7, cotton seed oil; Example 8, canola oil; Example 9, sunflower seed oil.

The compositions were tableted on a rotary compression machine using 19 millimeter high density polyethylene inserted tools. The average tablet hardness in Kiloponds (kp), and dissolution time at about 76° F. and dissolution time at about 38° F. (reported in units of seconds) was determined and is set forth in Table 2.

TABLE 2

| Component | Control 4 | Example 4 | Example 5 | Example 6 | Example 7 | Example 8 | Example 9 |
|---|---|---|---|---|---|---|---|
| Oil Description | Mineral Oil | Wheat | Safflower | Sesame Oil | Cotton Seed | Canola | Sunflower |
| | | Germ Oil | Oil | | Oil | Oil | Seed Oil |
| Citric Acid Fine | 47.89% | 47.89% | 47.89% | 47.89% | 47.89% | 47.89% | 47.89% |
| Granular | | | | | | | |
| Potassium | 16.76% | 16.76% | 16.76% | 16.76% | 16.76% | 16.76% | 16.76% |
| Bicarbonate | | | | | | | |
| Sorbitol Instant | 23.95% | 23.95% | 23.95% | 23.95% | 23.95% | 23.95% | 23.95% |
| Sodium | 7.18% | 7.18% | 7.18% | 7.18% | 7.18% | 7.18% | 7.18% |
| Bicarbonate | | | | | | | |
| Sodium | 3.59% | 3.59% | 3.59% | 3.59% | 3.59% | 3.59% | 3.59% |
| Carbonate | | | | | | | |
| Oil | 0.62% | 0.62% | 0.62% | 0.62% | 0.62% | 0.62% | 0.62% |
| Avg. Tablet | 7.7 | 8.3 | 9.5 | 9.1 | 9.4 | 8.7 | 8.9 |
| Hardness (kP) | | | | | | | |
| Avg. | 25 | 37 | 44 | 46 | 43 | 41 | 49 |
| Dissolution | | | | | | | |
| Time (~76° F.) | | | | | | | |
| Avg. | 59 | 92 | 99 | 105 | 97 | 93 | 107 |
| Dissolution | | | | | | | |
| Time (~38° F.) | | | | | | | |

### Control 5 and Examples 10 and 11

Uniform granulations were prepared by combining citric acid (granular), potassium bicarbonate, sorbitol instant, sodium bicarbonate, sodium carbonate, and an oil in a ribbon blender in the amounts (in units of % by weight based on the total weight of the formulation) set forth below in Table 3. When necessary, an ingredient was sieved using a number 12 sieve prior to addition to the mixture. The granulations were mixed for twenty-five minutes.

The oil in each formulation was as follows: Control 5, mineral oil; Example 10, wheat germ oil; Example 11, safflower oil.

The compositions were tableted on a rotary compression machine using 19 millimeter high density polyethylene inserted tools. The average tablet hardness in Kiloponds (kp), and dissolution time at about 76° F. and dissolution time at about 38° F. (reported in units of seconds) was determined and is set forth in Table 3.

TABLE 3

| | Control 5 | | Example 10 | | Example 11 | |
|---|---|---|---|---|---|---|
| Description | Mineral | | Wheat | | Safflower | |
| | Oil | | Germ Oil | | Oil | |
| Citric Acid Fine Granular | 46.77% | | 46.77% | | 46.77% | |
| Potassium Bicarbonate | 16.37% | | 16.37% | | 16.37% | |
| Sorbitol Instant | 23.39% | | 23.39% | | 23.39% | |
| Sodium Bicarbonate | 7.02% | | 7.02% | | 7.02% | |
| Sodium Carbonate | 3.51% | | 3.51% | | 3.51% | |
| Stevia | 2.34% | | 2.34% | | 2.34% | |
| Lubricating Oil | 0.61% | | 0.61% | | 0.61% | |
| Avg. Tablet Hardness | 9.6 | kp | 8.1 | kp | 9.2 | kp |
| Avg. Dissolution Time (~76° F.) | 544 | sec | 321 | sec | 355 | sec |
| Avg. Dissolution Time (~38° F.) | 859 | sec | 662 | sec | 689 | sec |

Other embodiments are within the claims.

All patents and references referred to herein are incorporated herein.

What is claimed is:

1. An effervescent tablet comprising:
from about 20% by weight to about 80% by weight effervescent agent comprising an acid and a base;
from about 5% by weight to about 25% by weight of a first binder; and
at least 0.1% by weight of an oil comprising at least one of safflower oil, sesame oil, sunflower oil, flax seed oil, and wheat germ oil,
the tablet having a hardness of at least 2 kiloponds.

2. The tablet of claim 1 further comprising from about 2% by weight to about 20% by weight of a first component that is insoluble in water, slightly soluble in water, or sparingly soluble in water, or exhibits delayed solubility in water.

3. The tablet of claim 2, wherein the first component that is insoluble in water, slightly soluble in water, or sparingly soluble in water, or exhibits delayed solubility in water comprises a sweetening agent and the effervescent tablet comprises from about 2% by weight to about 20% by weight of the sweetening agent.

4. The tablet of claim 3 further comprising from about 2% by weight to about 20% by weight of an agent selected from the group consisting of a flavor agent and a color agent, the agent being insoluble in water, slightly soluble in water, sparingly soluble in water, or exhibiting delayed solubility in water.

5. The tablet of claim 2, wherein the first component that is insoluble in water, slightly soluble in water, or sparingly soluble in water, or exhibits delayed solubility in water comprises an agent selected from the group consisting of a flavor agent and a color agent, the agent being present in the tablet in an amount of from about 4% by weight to about 20% by weight.

6. The tablet of claim 1 comprising at least 0.5% by weight oil.

7. The tablet of claim 2 comprising at least 0.5% by weight oil.

8. The tablet of claim 1 comprising at least 0.5% by weight wheat germ oil.

9. The tablet of claim 2 comprising at least 0.5% by weight wheat germ oil.

10. The tablet of claim 3 comprising at least 0.5% by weight wheat germ oil.

11. The tablet of claim 5 comprising at least 0.5% by weight wheat germ oil.

12. The tablet of claim 2 comprising at least 4% by weight of the first component.

13. The tablet of claim 6 comprising at least 4% by weight of the first component.

14. The tablet of claim 5, wherein the agent is a flavor agent comprising at least one of maltodextrin, dextrin, starch, modified starch, corn syrup solids, acacia gum, and agar.

15. The tablet of claim 4, wherein the agent is a flavor agent comprising a carbohydrate selected from the group consisting of sucrose, glucose, lactose, fructose, maltose, ribose, isomalt, mannitol, xylitol, lactitol, maltitol, pentatol, arabinose, pentose, xylose, galactose, hydrogenated starch hydrolysate and combinations thereof.

16. The tablet of claim 1, further comprising at least one of starch, modified starch, calcium phosphate, calcium phosphate dibasic, calcium phosphate tribasic, and lecithin.

17. The tablet of claim 1 further comprising from about 2% by weight to about 20% by weight of a first component selected from the group consisting of aspartame, stevia, cellulose, ethyl cellulose, maltodextrin, dextrin, starch, silicon dioxide, modified starch, alginate, butylated hydroxyanisole, butylated hydroxytoluene, calcium phosphate, hydroxypropyl cellulose, methyl cellulose, and combinations thereof.

18. The tablet of claim 17 comprising from about 4% by weight to about 20% by weight of the first component.

19. The tablet of claim 2, wherein the first component comprises at least one of aspartame and stevia.

20. The tablet of claim 2, wherein the tablet dissolves in 40° F. water in less than 150 seconds.

21. The tablet of claim 2, wherein the tablet has a hardness of at least 4 kiloponds and dissolves in 75° F. water in less than 225 seconds.

22. The tablet of claim 17, wherein the tablet has a hardness of at least 4 kiloponds and dissolves in 75° F. water in less than 225 seconds.

23. The tablet of claim 1, wherein the oil component has a hydrophilic lypophilic balance value of no greater than 10.

24. The tablet of claim 1, comprising at least 0.5% by weight of the oil component.

25. An effervescent tablet comprising:
from about 5% by weight to about 25% by weight binder;
from about 20% by weight to about 80% by weight effervescent agent comprising an acid and a base;
from about 2% by weight to about 20% by weight of a first component that is insoluble in water, slightly soluble in water, or sparingly soluble in water, or exhibits delayed solubility in water; and
at least 0.5% by weight of an oil component comprising at least one of
a fatty acid having an alkyl chain of at least 10 carbon atoms, safflower oil, sesame oil, sunflower oil, flax seed oil, canola oil, and wheat germ oil,
the tablet having a hardness of at least 2 kiloponds.

26. An effervescent tablet comprising:
from about 5% by weight to about 25% by weight binder;
from about 20% by weight to about 80% by weight of an effervescent agent comprising an acid and a base;
from about 2% by weight to about 20% by weight of a sweetening agent selected from the group consisting of aspartame and stevia; and
at least 0.1% by weight oil having a density greater than 0.900 grams per cubic centimeter,
the tablet having a hardness of at least 2 kiloponds and dissolving in water having a temperature of 40° F. in less than 200 seconds.

27. The tablet of claim 26, wherein the oil comprises wheat germ oil and the tablet comprises at least 0.5% by weight of the wheat germ oil.
